(19) United States
(12) Patent Application Publication
(10) Pub. No.: US 2016/0144537 A1
(43) Pub. Date: May 26, 2016

(54) METHOD FOR SHAPING A PLATE MADE OF A SINTERED AND RESTRUCTURED POLYTETRAFLUOROETHYLENE AND APPLICATIONS THEREOF

(71) Applicants: COMMISSARIAT À L'ÉNERGIE ATOMIQUE ET AUX ÉNERGIES ALTERNATIVES, Paris (FR); TECHNETICS GROUP FRANCE SAS, Saint Etienne (FR)

(72) Inventors: Laurent GUIMET, Unieux (FR); Sophie PARSY, Savigneux (FR); Michel LEFRANCOIS, Saint Etienne (FR)

(21) Appl. No.: 14/905,127

(22) PCT Filed: Jul. 11, 2014
(86) PCT No.: PCT/EP2014/064899

§ 371 Date: Jan. 14, 2016

(30) Foreign Application Priority Data
Jul. 15, 2013 (FR) 13 56947

(51) Int. Cl. B29C 43/00; F16K 7/12; B29C 43/18; B29C 43/02; B29C 43/52

(52) U.S. Cl. CPC B29C 43/003; B29C 43/02; B29C 43/52; B29C 43/18; F16K 7/12; B29K 2027/18

(57) ABSTRACT

The invention relates to a method for shaping a plate made of a sintered and restructured polytetrafluoroethylene and to the applications thereof.

This method comprises:
heating the plate to a temperature θ₁ at least equal to the melting temperature of a sintered polytetrafluoroethylene; and
shaping the thereby heated plate by compression in a compression mold.

Applications: manufacturing of notably diaphragms for diaphragm valves and pumps.

### TECHNICAL FIELD

The present invention relates to the field of manufacturing sintered and restructured polytetrafluoroethylene parts.

More specifically, it relates to a method for shaping a plate made of a sintered and restructured polytetrafluoroethylene, i.e. to a method which aims at transforming a plate made of a sintered and restructured PTFE into a part with different geometry (shape and/or dimensions) from the one exhibited by this plate.

This method may notably be used for manufacturing sintered and restructured polytetrafluoroethylene parts which, like parts made of a sintered but not restructured polytetrafluoroethylene which are found in the diaphragms of diaphragm valves and pumps, appear as films with at least one portion which is not planar.

So, the invention also relates to a method allowing the manufacturing of a part in a sintered and restructured polytetrafluoroethylene as defined above.

It further relates to a part in a sintered and restructured polytetrafluoroethylene which may be obtained by this method.

It still relates to a diaphragm for a diaphragm valve or pump comprising at least one part in a sintered and restructured polytetrafluoroethylene as defined above, as well as to a diaphragm valve or pump comprising such a diaphragm.

The invention first finds application in the field of the manufacturing of membranes for diaphragm valves or pumps for industrial use, but it may also find application in all the fields where it may be useful to have available non-planar parts in a sintered and restructured PTFE like for example, the manufacturing of membrane parts typically intended for biomedical applications.

### STATE OF THE PRIOR ART

As visible in FIG. 1, which schematically illustrates a typical exemplary diaphragm 10 which is used in diaphragm valves and pumps, this diaphragm comprises two parts superposed on each other, one of which, which is referenced as 12, is in polytetrafluoroethylene (or PTFE) while the other one, which is referenced as 13, is in an elastomer.

The parts 12 and 13, which are typically rectangular—as illustrated in FIG. 1—but which may also be circular, have a planar or substantially planar peripheral portion 14 and a central portion 15 with the shape of a dome. The part 12 further comprises on its face opposite to the one in contact with the part 13 and on the peripheral portion of this face, one or several ring-shaped bulges 18 which are intended to ensure a seal when the valve or the pump is in a closed position.

The parts 12 and 13 are connected at their center to a pin 16, conventionally made of metal, which allows the central portion of the parts 12 and 13—and therefore the central portion of the diaphragm 10—to deform under the effect of an actuator (not shown in FIG. 1), which is itself connected to the pin 16, and to pass from a convex/concave configuration to a concave/convex configuration and vice versa depending on whether the valve or the pump is in an open or closed position.

The part 12 is conventionally made by sintering a PTFE powder under high pressure and high temperature.

Yet, the mechanical flexural strength of a thereby obtained sintered PTFE part is quite limited because of the uncontrolled arrangement of the PTFE molecules within this part. This leads to a cracking tendency of the part 12 during successive transitions of the central portion of the diaphragm from the convex/concave configuration to the concave/convex configuration and vice versa and therefore to a relative rapid wear of this diaphragm.

In order to solve this problem, it was proposed in patent application EP 0 704 024 to make the parts 12 and 13 adherent together so as to use the elastomer of the part 13 and its elasticity for accompanying the movements of the part 12 and thereby to increase its mechanical flexural strength. In order to ensure an even better maintenance of the part 12, the elastomer of the part 13 may be reinforced with a woven grid which is incorporated into this part during its molding. However, experiment shows that this type of construction does not give satisfaction in practice. Indeed, mutual adhesion of the parts 12 and 13 has the effect of generating at the interface of these parts shear stresses which are at the origin of cracking phenomena of the part 12.

In patent U.S. Pat. No. 4,238,992, it was proposed to improve the flexibility of a PTFE diaphragm of a pneumatic pump by providing the portion of the diaphragm, on which is exerted the compressed air pressure, with a plurality of ring-shaped bulges, slightly spaced apart from each other. This solution is not either satisfactory. Indeed, sintered PTFE by nature has a lack of internal cohesion which makes it not very resistant to mechanical stresses as soon as its thickness becomes small, which is the case in the areas of the diaphragm located between the bulges. Further, these areas being by design areas with strong flexure, cracks finally occurring therein rapidly.

To this day, no solution exists actually allowing improvement in the mechanical flexural strength of the sintered PTFE parts which are used in the manufacturing of the diaphragms intended for diaphragm valves and pumps and hence the lifespan of these diaphragms.

So called <<restructured>> sintered PTFEs are known, which, while having qualities specific to conventional sintered PTFEs and, notably a chemical inertia and a thermal stability, have a flexibility, a creep resistance and a mechanical flexural strength clearly greater than those of the latter. The use of these sintered and restructured PTFEs in the manufacturing of diaphragms for diaphragm valves and pumps may therefore form an excellent solution for increasing the lifespan of this type of diaphragms.

The problem is that sintered and restructured PTFEs are obtained by a specific manufacturing process comprising a calendering operation which allows imparting to the PTFE molecules a so called <<crossed layers>> arrangement, at the origin of their improved properties of flexibility, creep resistance and mechanical flexural strength, but which is opposed to the possibility of manufacturing sintered and restructured PTFE parts in another way than as plates.

The Inventors therefore set their goal of managing to produce sintered and restructured PTFE parts which are not planar and which may notably have a shape similar to the one of the typically sintered PTFE parts entering the structure of diaphragms for diaphragm valves and pumps.

They also set the goal that these sintered and restructured PTFE parts may include on one of their faces, one or several bulges similar to the sealing bulges which the sintered PTFE parts entering the structure of the diaphragms for diaphragm valves and pumps typically have.

They further set the goal that it is impossible to integrate into these sintered and restructured PTFE parts during their manufacturing a pin of the type of the one which sintered PTFE parts entering the structure of the diaphragms for diaphragm valves and pumps typically have.

Yet, within the scope of their work, the Inventors noticed that unexpectedly, considering the high creep resistance which sintered and restructured PTFEs exhibit, it is possible to obtain a controlled creep of a sintered and restructured PTFE and to use this creep in order to transform a sintered and restructured PTFE plate into a part with a different geometry, which may notably include relief portions such as ring-shaped bulges if desired, and to add to it an insert such as a pin if this is also desired.

Furthermore, they noticed that the mechanical properties of sintered and restructured PTFE of the thereby obtained part surprisingly are not inferior to those of the sintered and restructured PTFE of the plate from which it stems and are even slightly superior to those of the latter.

And the present invention is based on these observations.

### DISCUSSION OF THE INVENTION

The invention therefore firstly relates to a method for shaping a plate in a sintered and restructured PTFE, which method comprises:
heating the plate to a temperature θ₁ at least equal to the melting temperature of a sintered PTFE; and
shaping the thereby heated plate by compression in a compression mold.

Thus, according to the invention, the shaping of a plate in a sintered and restructured PTFE is achieved by bringing this plate to a temperature equal to or greater than the melting temperature of a sintered PTFE—which allows having the material loose its crystalline structure and hence its creep resistance—and by subjecting the thereby heated plate to a compression in a compression mold.

In the foregoing and in the following, by <<melting temperature of a sintered PTFE>>, is meant the melting temperature exhibited by a PTFE obtained by sintering a PTFE powder and not having been subject to any restructuration treatment notably calendering. This melting temperature is 327° C.

Considering the thermal stability exhibited by sintered and restructured PTFEs, the heating of a plate in sintered and restructured PTFE induces a softening and a strong tendency to the creep of this material but by no means causes its liquefaction. The heated sintered and restructured PTFE plate therefore retains a solid consistency and may be easily handled, or even transported from one piece of equipment to another.

The result of this is that the heating of the plate may be carried out both outside the compression mold in which this plate is shaped by compression and inside this mold.

In every case, one will preferably make sure that the temperature θ₁ does not exceed 450° C. and this, in order to avoid destructuring the sintered and restructured PTFE.

In a first preferred embodiment of the shaping method according to the invention, the plate is heated outside the compression mold in which it is shaped by compression, in which case the method preferentially comprises:
introducing the plate into an oven heated beforehand to the temperature θ₁ and maintaining the plate in the thereby heated oven for 10 minutes to 60 minutes; and then
transferring the plate into the compression mold, this mold being heated beforehand to a temperature θ₂ which is at least equal to 200° C. (so as to maintain the core of the sintered and restructured PTFE in a semi-crystalline state during the compression) but which is lower than the melting temperature of the sintered PTFE, and compressing the plate in the thereby heated compression mold for 5 minutes to 30 minutes, under a pressure ranging from 50 MPa to 150 MPa.

As a result, the shaping of the sintered and restructured PTFE plate is completed and the part resulting from this shaping may be withdrawn from the compression mold.

In a second preferred embodiment of the shaping method according to the invention, the plate is heated inside the compression mold in which it is shaped by compression, in which case the method preferentially comprises:
introducing the plate in the compression mold, this mold being heated beforehand to the temperature θ₁, and compressing the plate in the thereby heated compression mold under a pressure ranging from 50 MPa to 150 MPa; and then
cooling the compression mold and maintaining the plate in the compression mold until the temperature of this mold is less than the melting temperature of the sintered PTFE.

As a result, the shaping of the sintered and restructured PTFE plate is completed and the part resulting from this shaping may be withdrawn from the compression mold.

According to the invention, the cooling of the compression mold may be obtained either by letting this mold cool naturally, once its heating has been stopped, or by facilitating this cooling, for example by injecting a fluid coolant into a system allowing the circulation of this fluid in the thickness of the walls of the compression mold.

It is obvious that, regardless of the way the shaping method according to the invention is implemented, the operating parameters such as the heating temperature of the compression mold, the pressure applied during the compression and the duration of this compression, will be advantageously selected depending on the degree of transformation which one intends to impose to the sintered and restructured PTFE plate, which transformation may notably ranges from the formation of a simple corrugation to the formation of a much more complex geometry, either with thickness reduction or not, either in the presence of reliefs or not, etc. In this respect, this selection may easily be optimized by one skilled in the art after applying a few routine tests in which one or several of the operating parameters mentioned above may be varied.

According to the invention, the method for shaping a sintered and restructured PTFE plate may a priori be applied to any type of plate made of a sintered and restructured PTFE.

Such plates are notably available from GARLOCK Sealing Technologies™ under the commercial reference GYLON™ and from TEADIT.

As mentioned earlier, the shaping method according to the invention may notably be used for manufacturing sintered and restructured PTFE parts which appear as films with at least one portion which is not planar.

So, the invention also relates to a method for manufacturing a film-shaped part, at least one portion of which is not planar, from a sintered and restructured PTFE plate, which method comprises the shaping of the plate by a method as defined above.

According to the invention, this method is preferably applied for manufacturing a part which has a thickness smaller than the thickness of the plate and/or which comprises a planar or substantially planar peripheral portion and a dome-shaped central portion.

In the latter case, the part may notably comprise a ring-shaped bulge, which is coaxial with the dome, on at least one of its faces and/or a pin which is integrated to the top of the dome.

The manufacturing of this part may notably be achieved by using the first preferred embodiment of the shaping method described above, in which case it is preferred:
on the one hand, that the oven be heated beforehand to a temperature (θ₁) ranging from 365° C. to 375° C. and that the plate be maintained in the thereby heated oven for 10 minutes to 15 minutes; and
on the other hand, that the compression mold be heated beforehand to a temperature (θ₂) ranging from 240° C. to 280° C. and that the plate be compressed in the thereby heated compression mold for 5 minutes to 10 minutes, under a pressure ranging from 100 MPa to 150 MPa.

Alternatively, it may also be achieved by using the second preferred application method of the shaping method described above, in which case it is preferred:
on the one hand, that the compression mold be heated beforehand to a temperature (θ₁) ranging from 330° C. to 350° C. and that the plate be compressed in the thereby heated compression mold under a pressure ranging from 100 MPa to 150 MPa; and
on the other hand that the plate be maintained under compression at least until the temperature of the compression mold attains 200° C.

The invention also relates to a sintered and restructured PTFE part as a film, at least one portion of which is not planar, which part may be obtained by a manufacturing method as defined earlier.

The invention further relates to a diaphragm for a diaphragm valve or pump, which comprises at least one part in a sintered and restructured PTFE as defined above, this sintered and restructured PTFE not comprising any reinforcing filler of the silica, graphite, barium sulfate, glass microspheres type or the like.

Such a sintered and restructured PTFE is for example available from GARLOCK Sealing Technologies™ under the commercial reference GYLON™ Style 3522.

Preferably, this diaphragm further comprises at least one part made of an elastomer, the sintered and restructured PTFE part and the elastomer part being superposed.

The invention still relates to a valve or pump with a diaphragm, which valve or pump comprises at least one diaphragm as defined above.

### SHORT DESCRIPTION OF THE FIGURES

FIG. 1, having already been commented on, schematically illustrates a typical example of a diaphragm of a diaphragm valve or pump.

FIG. 2 schematically illustrates, in a sectional view and in an open condition, an example of a compression mold giving the possibility of manufacturing, according to the invention, a sintered and restructured PTFE part intended to enter the structure of a diaphragm of a diaphragm valve or pump of the type of the one illustrated in FIG. 1.

FIGS. 3A and 3B schematically illustrate an example of use of the compression mold shown in FIG. 2 for the manufacturing, according to the invention, of a sintered and restructured PTFE part intended to enter the structure of a diaphragm for a diaphragm valve or pump of the type of the one illustrated in FIG. 1; FIG. 3A shows a sintered and restructured PTFE plate, having been heated beforehand outside the compression mold, after its transfer into the compression mold but before its compression in this mold, while FIG. 3B shows the sintered and restructured PTFE part as obtained after compression of the plate in the compression mold but before removal of said part from this mold.

FIG. 4 illustrates the breakage elongation values, expressed in %, depending on the tensile stress, expressed in MPa, as obtained during tensile tests having been conducted on samples of a plate made of a sintered and restructured PTFE (curve A) and on samples of a part resulting from the shaping of this plate with the shaping method according to the invention (curve B).

### DETAILED DISCUSSION OF A PARTICULAR EMBODIMENT

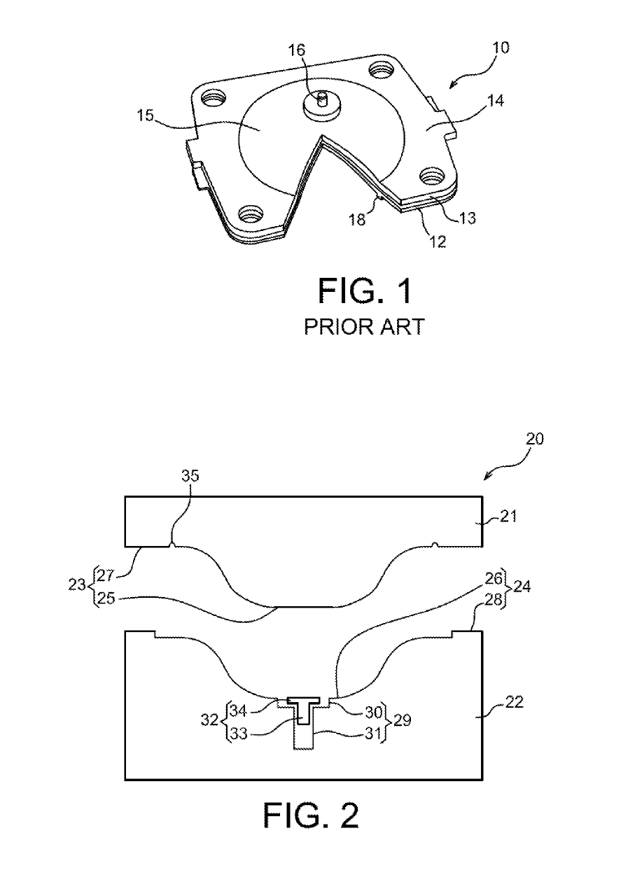

First of all, reference is made to FIG. 2 which schematically illustrates, in a sectional view and under an open condition, an exemplary compression mold 20 allowing manufacturing, according to the invention, a part in a sintered and restructured PTFE intended to enter the structure of a diaphragm of a diaphragm valve or pump of the type of the one illustrated in FIG. 1.

As visible in this FIG., the compression mold 20 comprises an upper half-mold 21 and a lower half-mold 22 which together delimit, in the closed condition, a cavity with shape and dimensions conjugate with those of the sintered and restructured PTFE part which one wishes to manufacture.

Thus, the surfaces 23 and 24 respectively, of the half-molds 21 and 22 which are located facing each other comprise a central portion, 25 and 26 respectively, which is convex for the upper half-mold 21 and which is concave for the lower half-mold 22, these convex and concave central portions both being of a circular horizontal section. Further, the surface 23 of the upper half-mold 21 comprises a peripheral portion 27 which is planar while the surface 24 of the lower half-mold 22 comprises a peripheral portion 28 which is shifted upwards relatively to the edge of the central portion 26.

The peripheral portion 27 of the upper half-mold 21 comprises a ring-shaped groove 35, of the same axis as the dome forming the central portion of this half-mold, for forming on the peripheral portion of the part a sealing bulge similar to the bulge 18 shown in FIG. 1.

Further, for integrating into the part a pin similar to the pin 16 shown in FIG. 1, the central portion 26 of the half-mold 21 itself comprises an axisymmetrical recess 29 which comprises an upper portion 30 and a lower portion 31, the diameter of which is less than that of the upper portion 30. A pin 32, comprising an axial rod 33 and a head 34 located at the upper end of the rod 33, is housed in the recess 29, the rod 33 being located in the lower portion 31 of this recess and the head 34 being located in the upper portion 30 of said recess.

The half-molds 21 and 22 are provided with heating means (not shown in FIG. 2) such as for example electric resistors which are housed in the walls of these half-molds.

They may also be provided with cooling means (not shown in FIG. 2) such as for example means for circulating a fluid coolant which are also housed in their walls.

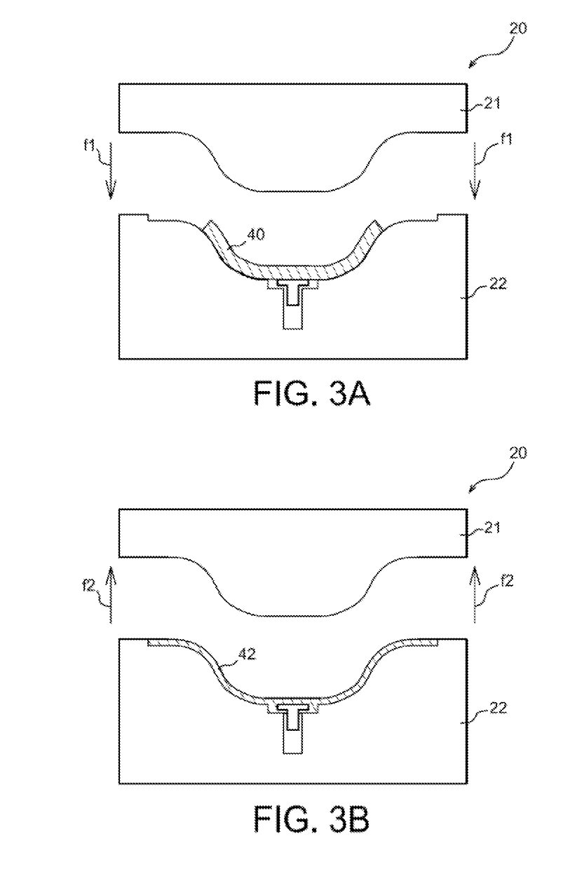

Now reference is made to FIGS. 3A and 3B which schematically illustrate an example of use of the compression mold 20.

As visible in FIG. 3A, a sintered and restructured PTFE plate 40, having been heated beforehand in an oven, for example at a temperature of 370° C. for 10 minutes, is introduced into the compression mold 20 and deposited on the central portion 26 of the lower half-mold 22.

The compression mold 20 is itself heated, for example to a temperature of 240° C.

After closing the compression mold 20 (by moving the upper half-mold 21 in the direction of the arrows f1), a pressure, for example 125 MPa, is applied on the upper half-mold 21, for example by means of a press (not shown in FIG. 3A), and this pressure is maintained, for example for 5 minutes.

The heat treatment to which was subject the plate 40 before its transfer into the compression mold having caused the loss of its crystalline structure and of its creep resistance to the sintered and restructured PTFE, this material strongly creeps in the compression mold 20 until it occupies the whole cavity delimited by the half-molds 21 and 22, including the upper portion 30 of the recess 29. It thus surrounds the head 34 of the pin 32, which allows the insertion of this pin in the sintered and restructured PTFE.

After reopening the compression mold 20 (by displacement of the upper half-mold 21 in the direction of the arrows f2), the sintered and restructured PTFE part 42 shown in FIG. 3B is obtained. This part may then be withdrawn from this mold.

Tensile tests have been conducted on samples of a plate made of a sintered and restructured PTFE with a thickness of 3 mm (GYLON™ Style 3522) and on samples of a part with a thickness of 1.2 mm resulting from the shaping of this plate by a method similar to the one which has just been described.

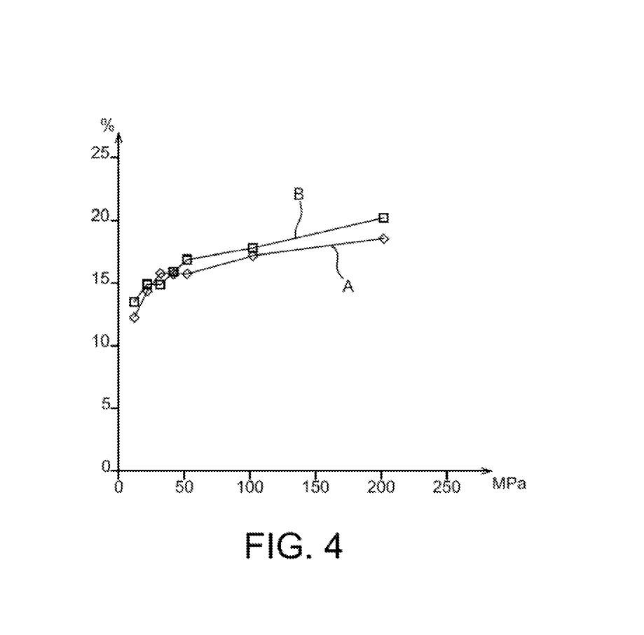

The results of these tests (breakage elongation values, expressed in %, versus the tensile stress, expressed in MPa) are illustrated in FIG. 4, the curve A corresponding to the results obtained for samples of the sintered and restructured PTFE plate and curve B corresponding to the results obtained for the part resulting from the shaping of this plate.

This FIG. shows that the initial stiffness of the sintered and restructured PTFE is not decreased by the shaping method according to the invention, unlike what might have been feared, and is even slightly increased. Thus, the controlled creep as applied according to the invention seems to give the possibility to sintered and restructured PTFE of retaining its original mechanical properties, or even to substantially improve them.

References Mentioned

Patent application EP 0 704 024

Patent U.S. Pat. No. 4,238,992

1. A method for shaping a plate made of a sintered and restructured polytetrafluoroethylene, comprising:
heating the plate to a temperature θ₁ at least equal to a melting temperature of a sintered polytetrafluoroethylene; and
shaping the thereby heated plate by compression in a compression mold.

2. The method of claim 1, wherein the heating of the plate is carried out outside the compression mold.

3. The method of claim 2, comprising:
introducing the plate in an oven heated beforehand to the temperature θ₁ and maintaining the plate in the thereby heated oven for 10 minutes to 60 minutes; and then
transferring the plate into the compression mold, the compression mold being heated beforehand to a temperature θ₂ at least equal to 200° C. but less than the melting temperature of the sintered polytetrafluoroethylene, and compressing the plate in the thereby heated compression mold for 5 minutes to 30 minutes, under a pressure ranging from 50 MPa to 150 MPa.

4. The method of claim 1, wherein the heating of the plate is carried out inside the compression mold.

5. The method of claim 4, comprising:
introducing the plate in the compression mold, the compression mold being heated beforehand to the temperature θ₁, and compressing the plate in the thereby heated compression mold under a pressure ranging from 50 MPa to 150 MPa; and then
cooling the compression mold and maintaining the plate under compression until the temperature of the compression mold is less than the melting temperature of the sintered PTFE.

6. A method for manufacturing a film-shaped part made of a sintered and restructured polytetrafluoroethylene, the film-shaped part having at least one not planar portion, from a plate made of a sintered and restructured polytetrafluoroethylene, comprising:
heating the plate to a temperature θ₁ at least equal to a melting temperature of a sintered polytetrafluoroethylene; and
shaping the thereby heated plate by compression in a compression mold, the compression mold comprising at least one not planar portion, and thereby obtaining the film-shaped part.

7. The method of claim 6, wherein the part has a smaller thickness than a thickness of the plate.

8. The method of claim 6, wherein the part comprises a planar or substantially planar peripheral portion and a dome-shaped central portion.

9. The method of claim 8, wherein the peripheral portion of the part comprises two opposites faces and a ring-shaped bulge, coaxial with the dome, on at least one of the faces.

10. The method of claim 8, wherein the part comprises a pin which is integrated to a top of the dome.

11. The method of claim 6, comprising:
the compression mold is heated.
introducing the plate in an oven heated beforehand to the temperature θ₁ and maintaining the plate in the thereby heated oven for 10 minutes to 60 minutes; and then
transferring the plate into the compression mold, the compression mold being heated beforehand to a temperature θ₂ at least equal to 200° C. but less than the melting temperature of the sintered polytetrafluoroethylene, and compressing the plate in the thereby heated compression mold for 5 minutes to 30 minutes, under a pressure ranging from 50 MPa to 150 MPa.

12. The method of claim 6, wherein:
the compression mold is
the plate is maintained under compression at least until the temperature of the compression mold attains 200° C.
introducing the plate in the compression mold, the compression mold being heated beforehand to the temperature θ₁, and compressing the plate in the thereby heated compression mold under a pressure ranging from 50 MPa to 150 MPa; and then
cooling the compression mold and maintaining the plate under compression until the temperature of the compression mold is less than the melting temperature of the sintered PTFE.

13. A film-shaped part made of a sintered and restructured polytetrafluoroethylene, the part having at least one not planar portion, which may be obtained by a method comprising:
heating a plate made of a sintered and restructured polytetrafluoroethylene to a temperature θ₁ at least equal to a melting temperature of a sintered polytetrafluoroethylene; and
shaping the thereby heated plate by compression in a compression mold, the compression mold comprising at least one not planar portion, and thereby obtaining the film-shaped part.

14. A diaphragm for a diaphragm valve or pump, which comprises at least one sintered and restructured polytetrafluoroethylene part of claim 13, the sintered and restructured polytetrafluoroethylene not comprising any reinforcement filler.

15. The diaphragm of claim 14, which further comprises at least one part made of an elastomer, the part made of the sintered and restructured polytetrafluoroethylene and the part made of the elastomer being superposed.

16. A diaphragm valve or pump, which comprises at least one diaphragm of claim 14.

17. The method of claim 11, wherein:
the oven is heated beforehand to a temperature ranging from 365° C. to 375° C. and the plate is maintained in the thereby heated oven for 10 minutes to 15 minutes; and
the compression mold is heated beforehand to a temperature ranging from 240° C. to 280° C. and the plate is compressed in the thereby heated compression mold for 5 minutes to 10 minutes, under a pressure ranging from 100 MPa to 150 MPa.

18. The method of claim 12, wherein:
the compression mold is heated beforehand to a temperature ranging from 330° C. to 350° C. and the plate is compressed in the thereby heated compression mold under a pressure ranging from 100 MPa to 150 MPa; and
the plate is maintained under compression at least until the temperature of the compression mold attains 200° C. by the cooling.
